(19) United States
(12) Patent Application Publication
(10) Pub. No.: US 2008/0096764 A1
(43) Pub. Date: Apr. 24, 2008

(54) SYSTEM AND METHOD FOR IMPREGNATION OF SUPERCONDUCTIVE WIRES

(76) Inventors: Wayne Bentley, Oxon (GB); Paul Anthony Bruce Bircher, Oxfordshire (GB); Adam Paul Johnstone, West Sussex (GB); Rachel Davida Jones, Oxon (GB); Michael John Disney Mallett, Wellington (NZ); Adrian Mark Thomas, Oxon (GB)

Correspondence Address: SCHIFF HARDIN, LLP;PATENT DEPARTMENT, 6600 SEARS TOWER, CHICAGO, IL, 60606-6473, US

(21) Appl. No.: 11/875,002

(22) Filed: Oct. 19, 2007

(30) Foreign Application Priority Data
Oct. 20, 2006 (GB) 0620790.6

(51) Int. Cl. H01B 12/14

(52) U.S. Cl. 505/230; 427/62; 118/68

(57) ABSTRACT

A system for impregnating a superconductive wire surrounded by insulation with a resin provided in liquid form in a vessel, has an input arrangement that introduces the wire into the vessel, a transport device that moves the wire through the resin in the vessel and a pressure applicator that applies pressure to the wire, transversely to its length, at at least one location within the vessel while in contact with the resin, so as to expel gases otherwise trapped within the insulated wire. Each pressure applicator is formed by a co-operative pair of pinch rollers, with one pinch roller of each pair being doubly flanged to provide a substantially central recess to accommodate the insulated wire, and the other pinch roller of each pair is formed with a central tongue dimensioned to enter the recess to trap the wire therein and apply pressure thereto.

### BACKGROUND OF THE INVENTION

1. Field of the Invention

This invention relates to systems and methods for the impregnation, with a medium such as an epoxy resin, of insulated superconductive wires, and it relates particularly, though not exclusively, to such systems and methods for superconductive wires wrapped with braided insulation. Wires so impregnated are typically wound into coils and used, for example, in magnetic resonance imaging (MRI) scanners employed for medical and other purposes.

2. Description of the Prior Art

It is known that impregnation of the type generally described above is difficult to achieve with the reliability needed for use in critical superconductive applications. In particular, when a so-called “wet-winding” process is used, wherein the wire to be impregnated is passed, on its way to a former on which it is to be wound, through a bath or other vessel containing the epoxy resin medium in liquid form, difficulties arise due to entrapment of gases between the superconductive wire and braided insulation. The trapped gases militate against adequate impregnation and typically result in the production of coil structures with insufficient strength for use in superconductive magnets for applications such as MRI scanners.

### SUMMARY OF THE INVENTION

For this reason, other impregnation procedures, such as vacuum impregnation and the co-winding of partially cured components onto a former have been advocated. However, the wet winding process is preferred for several reasons, and it is an object of this invention to provide a system and method for the impregnation of superconductive wires in which the above-mentioned difficulties are reduced or eliminated.

According to the invention a system for impregnating superconductive wires surrounded by insulation with a resin provided in liquid form in a vessel, has a transport unit that moves the wire through the resin in the vessel and a pressure applicator that applies pressure to the wire, transversely to its length, at at least one location within the vessel while in contact with the resin, so as to expel gases that would otherwise be trapped within the insulated wire. The, or each, pressure applicator has a co-operative pair of pinch rollers and one pinch roller of each pair is doubly flanged to provide a substantially central recess to accommodate the insulated wire, and the other pinch roller of each pair is formed with a central tongue dimensioned to enter this recess to trap the wire therein and apply pressure thereto.

Preferably, the insulation is wrapped around the wire and it is further preferred that the insulation is braided.

The liquid resin conveniently, though not necessarily, is a mixed epoxy resin.

In a preferred embodiment, the vessel comprises an elongate tank provided with a number of pressure applicators acting serially upon said wire, each pressure applicator being disposed at a respective location along the tank.

The pinch rollers of a pair may be resiliently urged toward one another so as to apply the aforementioned pressure to the wire, or they may be configured in a fixed relationship designed to pinch the insulated wire with a predetermined, fixed pressure.

In circumstances where multiple pairs of rollers are provided, distributed along the tank, the rollers of each of the pairs may be resiliently urged toward one another, or the rollers of each of the pairs may be disposed at a predetermined, fixed spatial relationship, or there may be a combination of resiliently-mounted and fixedly-mounted pairs.

It is preferred that at least one pair of rollers is formed with an interacting traction promoter so that a positive driving action is imparted to the wire as it traverses the elongate tank. In preferred embodiments, such a traction promoter is formed by co-operative gear teeth.

It is preferred in some embodiments to provide a control device to adjust the viscosity of the liquid resin in the vessel, so as to promote wetting of the wire by the resin a nd/or the adhesion of the resin to the insulated wire. Such a control device can be, in some embodiments, a heating device heats the resin. A servo control system may be provided to maintain the temperature of the resin within prescribed limits preset in relation to given operational criteria.

In some embodiments, an agitation, such as ultrasonic agitating devices may be provided to further promote removal of gases from the impregnated and insulated wire.

It is much preferred to directly wind the wire onto a former after leaving the tank, and a tensioned system can be applied to move the wire through the tank from a temporary storage unit onto said former.

An input arrangement may be provided for introducing the wire into the vessel. The input arrangement can include an inlet seal and a guiding roller. A flanged exit guiding roller and an outlet seal also may be provided.

The invention also encompasses a method of impregnating, superconductive wires surrounded by insulation with a resin; the method including the steps of: (a) providing the resin in liquid form in a vessel; (b) introducing the wire into the vessel; (c) moving the wire through the resin in the vessel; and (d) applying pressure to the wire, transversely to its length, at at least one location within the vessel and while in contact with the resin, so as to expel gases that would otherwise be trapped within the insulated wire. The step of applying pressure can be a co-operative pair of pinch rollers, with one pinch roller of each pair being doubly flanged to provide a substantially central recess to accommodate the insulated wire, and the other pinch roller of each pair is formed with a central tongue dimensioned to enter the recess to trap the wire therein and apply pressure thereto.

### BRIEF DESCRIPTION OF THE PREFERRED EMBODIMENTS

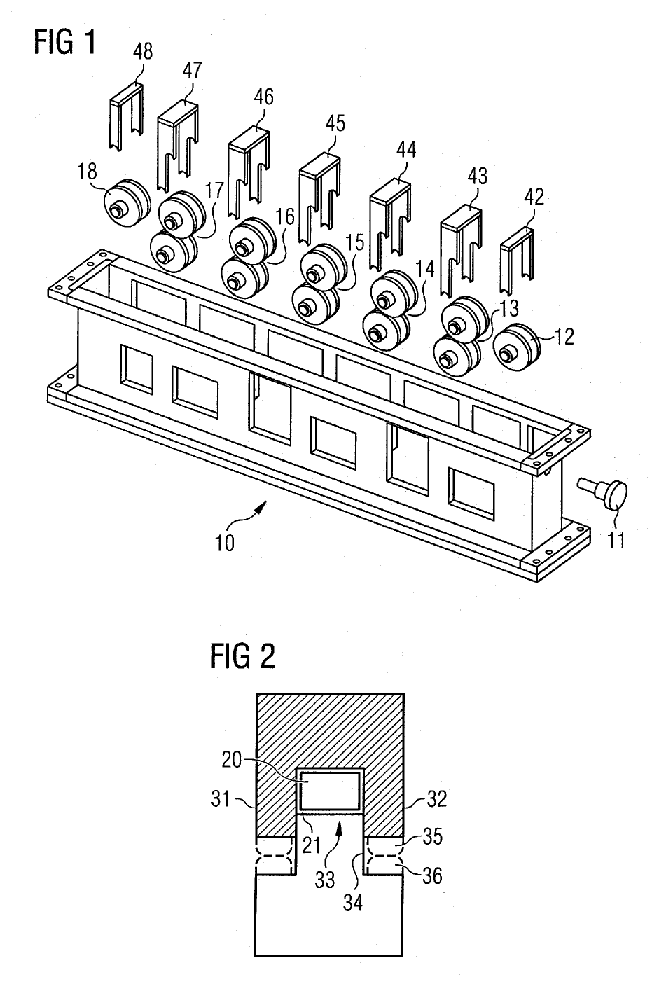

FIG. 1 shows, in an exploded perspective view, a system according to one embodiment of the invention.

FIG. 2 shows, schematically and in side elevation, a pair of rollers included in the system of FIG. 1, together with a cross-sectional view of a braided wire to illustrate a typical relationship between the wire and the rollers.

### DESCRIPTION OF THE PREFERRED EMBODIMENTS

Referring now to the drawings, the system of this exemplary embodiment comprises a vessel in the form of an elongate tank 10 which contains a liquid medium (not shown) such as a mixed epoxy resin of known formulation. A superconductive wire 20 (shown in cross-section in FIG. 1), wrapped with braided insulation shown schematically at 21, to be impregnated with the resin medium runs longitudinally through the tank 10 on its way to a former (not shown) on which the impregnated wire is to be wound to form a coil which may, for example, be utilized as a superconductive magnet in an MRI scanner. The wire is preferably maintained under tension to ensure that the overall impregnation and coil-forming process conforms to a prescribed standard.

The braid-covered wire 20, 21 is introduced into the tank 10 by threading it through an inlet seal 11 which resists unwanted egress of the resin medium from the tank 20, passes over a flanged inlet guiding roller 12 and then passes through a pressure applicator formed by at least one pair of pinch rollers such as 13 configured to compress the braid-covered wire 20, 21 whilst it is passing through the resin medium, so as to release gases which would otherwise remain trapped between the wire 20 and its braided cover 21.

Such entrapped gases would, as previously mentioned, compromise the integrity of the wound coil were they allowed to remain.

In this particular example, the pressure applicator includes five pairs of pinch rollers 13 to 17 through which the wire 20, 21 is passed serially, and the impregnated wire 20, 21, upon leaving the last pinch roller pair 17, is guided by a flanged exit guiding roller 18 out of the tank 10 through an outlet seal (not shown) and passes to the aforementioned former on which it is to be wound to form a coil.

In this embodiment of the invention, one pinch roller of each pair such as 13 is doubly flanged, as shown at 31, 32 in FIG. 2, to provide a substantially central recess 33 to accommodate the insulated wire 20, 21, and the other pinch roller of each pair such as 13 is formed with a central tongue 34 dimensioned to enter the recess 33 to trap the wire 20, 21 therein and apply pressure thereto.

The pinch rollers of a pair such as 13 may be resiliently urged toward one another so as to apply the pressure to the wire 20, 21, or they may be configured into a fixed relationship designed to pinch the insulated wire 20, 21 with a predetermined, fixed pressure.

It will be appreciated that where, as in this example, multiple pairs of rollers 13 to 17 are provided, distributed along the tank 10, the rollers of each of the pairs may be resiliently urged toward one another, or the rollers of each of the pairs 13 to 17 may be disposed at a predetermined, fixed spatial relationship, or there may be a mix of resiliently-mounted and fixedly-mounted pairs. Moreover, the spacing between adjacent pairs of rollers may be constant or may vary from pair to pair as between two or more of the pairs, in dependence upon design and impregnation criteria.

It is preferred that at least one pair of rollers such as 13 is formed with interacting traction promoter so that a positive driving action is imparted to the wire 20, 21 as it traverses the elongate tank 10. In this example, such a traction promoter is formed by co-operative gear teeth 35 and 36 which are arranged to mesh, so as to reduce or prevent slippage between rollers of a pair.

In this example, the pairs of pressure-applying pinch rollers 13 to 17, and the inlet and outlet guiding rollers 12 and 18, are mounted to the tank 10 by means of respective roller retainers 42 to 48. In this embodiment, the rollers of each pressure-applying pair 13 to 17 are mounted substantially one above the other, though with a slight longitudinal offset in the direction axial of the wire and the tank. In these circumstances, it is preferred that the upper roller of each pair is formed with flanges such as 31, 32 creating the recess 33, and correspondingly that the lower roller of each pair has the tongue such as 34 which engages into the recess 33; the upper, flanged roller acting primarily as a guide and the lower, tongued roller applying the pressure. If desired, however, some or all of the roller pairs may be arranged with the flanged roller lower than the tongued roller.

Although such provision is not used in the present embodiment of the invention, it is envisaged that, in some embodiments, a control arrangement may be provided to adjust the viscosity of the liquid medium in the vessel, so as to promote the wetting of the wire 20, 21 by the resin medium and/or the adhesion of the resin medium to the insulated wire 20, 21. Such a control arrangement can include, in some embodiments, a heater to heat the medium, and in this respect attention is invited to JP 3179710, which advocates heating a wire (already coated with resin) to between 100 and 200 deg. C. A servo control system may be provided to maintain the temperature of the medium within prescribed limits preset in relation to given operational criteria.

Furthermore, in some embodiments of the invention, an agitator means, such as ultrasonic agitating devices, may be provided to further promote removal of gases from the impregnated and insulated wire 20, 21. In such circumstances, agitation may be applied generally to the resin medium, for example by way of an agitator built into the base or an upright wall of the tank 10, so as to encourage entrapped gases to move to the surface of the medium, from which they can be allowed to exit naturally, or from which they may be actively withdrawn, for example by the application of suction. Alternatively, or in addition, the agitation may be specifically focused in one or more of the areas of applied pressure, for example by applying agitation forces to the roller retainer of one or more of the roller pairs 13 to 17.

Replenishment of the resin medium to replace medium impregnated into the wire 20, 21 is preferably implemented automatically such that the level of resin medium in the tank 10 is maintained at or near a predetermined level by means of a servo system of known kind.

It is further preferred that the wire 20, 21, duly impregnated, is directly wound onto a former after leaving the tank 10, and for this purpose a tensioned system can be applied to move the wire through the tank from an initial storage unit onto the former.

Although modifications and changes may be suggested by those skilled in the art, it is the intention of the inventors to embody within the patent warranted hereon all changes and modifications as reasonably and properly come within the scope of their contribution to the art.

We claim as our invention:

1. A system for impregnating a superconductive wire surrounded by insulation with a resin provided in liquid form in a vessel, comprising a transport arrangement that moves the wire through the resin in the vessel and a pressure applicator that applies pressure to the wire, transversely to its length, at at least one location within the vessel while the wire is in contact with said resin, so as to expel gases otherwise trapped within the insulated wire, said pressure applicator comprising at least one co-operative pair of pinch rollers, with one pinch roller of each pair being doubly flanged to provide a substantially central recess to accommodate the insulated wire, and the other pinch roller of each pair being formed with a central tongue dimensioned to enter said recess to trap the wire therein and apply said pressure thereto.

2. A system according to claim 1, wherein the insulation is wrapped around the wire.

3. A system according to claim 2, wherein the insulation is braided.

4. A system according to claim 1, wherein the liquid resin comprises a mixed epoxy resin.

5. A system according to claim 1, wherein the vessel comprises an elongate tank provided with a plurality of said pressure applicators disposed to act serially upon said wire, with each pressure applicator is disposed at a respective location along the tank.

6. A system according to claim 1, further including a bias arrangement that resiliently urges the pinch rollers of a pair toward one another so as to apply said pressure to the wire.

7. A system according to claim 1, further comprising a roller fixture that configures the pinch rollers of a pair into a fixed relationship designed to pinch the insulated wire with a predetermined, fixed pressure.

8. A system according to claim 1 wherein said pressure applicator comprises a plurality of said pairs of pinch rollers, said plurality of pairs of pinch rollers comprising a first group of said pairs wherein the pinch rollers thereof are biased toward each other to apply said pressure to said wire, and a second group of pairs wherein said pinch rollers are held in a roller fixture to pinch the insulated wire therebetween with a predetermined, fixed pressure.

9. A system according to claim 1, wherein at least one pair of rollers is formed with a traction promoter that imparts a positive driving action to the wire as the wire traverses the elongate tank.

10. A system according to claim 9, wherein said traction promoter comprises co-operative gear teeth.

11. A system according to claim 1, further comprising a control arrangement that adjusts the viscosity of the liquid resin in the vessel, to promote wetting of the wire by the resin and/or the adhesion of the resin to the insulated wire.

12. A system according to claim 11, wherein said control arrangement comprises a heater that heats the resin.

13. A system according to claim 12, further comprising a servo control system that maintains a temperature of the resin within prescribed limits.

14. A system according to claim 1, further comprising an agitator that agitates the resin to further promote removal of gases from the impregnated and insulated wire.

15. A system according to claim 14, wherein said agitator comprises at least one ultrasonic agitating device.

16. A system according to claim 15, further comprising a replenishing arrangement that automatically replenishes the liquid resin in the vessel to replace resin impregnated into the wire.

17. A system according to claim 16, further comprising a servo control that maintains a level of said liquid resin at or near a predetermined level.

18. A system according to claim 1, wherein the impregnated wire is directly wound onto a former to form a coil adapted for use in a superconductive magnet arrangement.

19. A system according to claim 1, further comprising an inlet arrangement that introduces the wire into the vessel, comprising an inlet seal in said vessel and a guiding roller.

20. A system according td claim 1, further comprising a flanged exit guiding roller and an outlet seal in said vessel.

21. A method of impregnating with a superconductive wire surrounded by insulation with resin, comprising the steps of:
a) providing said resin in liquid form in a vessel;
b) introducing the wire into the vessel;
c) moving the wire through the resin in the vessel;
d) applying pressure to the wire, transversely to its length, at at least one location within the vessel and while the wire is in contact with said resin, so as to expel gases otherwise trapped within the insulated wire; and
applying said pressure by passing the wire through at least one co-operative pair of pinch rollers, with one pinch roller of each said pair being doubly flanged to provide a substantially central recess to accommodate the insulated wire, and the other pinch roller of each pair being formed with a central tongue dimensioned to enter said recess to trap the wire therein and apply said pressure thereto.
